(19) United States
(12) Patent Application Publication
(10) Pub. No.: US 2013/0219342 A1
(43) Pub. Date: Aug. 22, 2013

(54) MOBILE TERMINAL DEVICE, STORAGE MEDIUM AND APPLICATION EXECUTION CONTROL METHOD

(71) Applicant: Kyocera Corporation, (US)

(72) Inventors: Mitsukuni NOSOU, Osaka (JP); Tomoki IWAIZUMI, Osaka (JP)

(73) Assignee: KYOCERA CORPORATION, Kyoto (JP)

(21) Appl. No.: 13/772,116

(22) Filed: Feb. 20, 2013

(30) Foreign Application Priority Data
Feb. 21, 2012 (JP) 2012-035663

(51) Int. Cl. G06F 3/0482

(52) U.S. Cl. CPC G06F 3/0482
USPC 715/835

(57) ABSTRACT

A mobile terminal device includes an image generating module which generates a first image by which an user selects one of contact objects respectively correlated to contact information and a second image by which the user selects one of application programs utilizing contact information, and displays the first image and the second image on a display module; a receiving module which receives a first operation with respect to the first image and a second operation with respect to the second image; and an executing module which executes a processing of activating the application program selected by the second operation, and of applying, to the activated application program, the contact information correlated to the contact object selected by the first operation, as contact information to be utilized in the activated application program, based on a determination that the first operation and the second operation are received by the receiving module.

This application claims priority under 35 U.S.C. Section 119 of Japanese Patent Application No. 2012-035663 filed Feb. 21, 2012, entitled “MOBILE TERMINAL DEVICE, PROGRAM AND APPLICATION EXECUTION CONTROL METHOD”. The disclosure of the above application is incorporated herein by reference.

### BACKGROUND OF THE INVENTION

1. Field of the Invention

The present invention relates to a mobile terminal device such as a mobile phone, a PDA (Personal Digital Assistant), a tablet PC, and an electronic book reader, etc.; a storage medium storing a computer program suitable for use in the mobile terminal device; and an application execution control method suitable for use in the mobile terminal device.

2. Disclosure of Related Art

Conventionally, in a mobile terminal device such as a mobile phone, etc., a user is allowed to execute various application programs (hereinafter, called as “applications”) with use of contact destinations registered in advance in an address book.

For instance, there is known a configuration, in which an image linked to an application utilizing contact destinations by a link function is included in a display screen in a state that information about the contact destinations related to contact objects such as persons or organizations is displayed. For instance, in the case where an application linked to an image is an electronic mail application, the electronic mail application is activated in response when a user selects the image linked to the application, whereby an electronic mail address to be included as the contact destination that has been displayed before the linked image is selected is extracted as information relating to an electronic mail recipient in the activated electronic mail application.

In the above configuration, however, the user is required to open the address book and display a contact destination on a screen before selecting a linked image. In the case where the user utilizes an application such as an electronic mail application, it is desirable to incorporate a contact destination in the application to be executed by a simplified operation of the user.

### SUMMARY OF THE INVENTION

A first aspect of the invention is directed to a mobile terminal device. The mobile terminal device according to the first aspect includes a display module; an image generating module which generates a first image by which an user selects one of a plurality of contact objects respectively correlated to contact information and a second image by which the user selects one of a plurality of application programs utilizing contact information, and displays the first image and the second image on the display module; a receiving module which receives a first operation with respect to the first image and a second operation with respect to the second image; and an executing module which executes a processing of activating the application program selected by the second operation, and of applying, to the activated application program, the contact information correlated to the contact object selected by the first operation, as contact information to be utilized in the activated application program, based on a determination that the first operation and the second operation are received by the receiving module.

A second aspect of the invention is directed to a storage medium which stores a computer program to be applied to a mobile terminal device. The computer program provides the mobile terminal device with a function of generating a first image by which an user selects one of a plurality of contact objects respectively correlated to contact information and a second image by which the user selects one of a plurality of application programs utilizing contact information, and of displaying the first image and the second image on a display module; a function of receiving a first operation with respect to the first image and a second operation with respect to the second image; and a function of activating the application program selected by the second operation, and of applying, to the activated application program, the contact information correlated to the contact object selected by the first operation, as contact information to be utilized in the activated application program, based on a determination that the first operation and the second operation are received.

A third aspect of the invention is directed to an application execution control method for a mobile terminal device. The application execution control method according to the third aspect includes a step of generating a first image by which an user selects one of a plurality of contact objects respectively correlated to contact information and a second image by which the user selects one of a plurality of application programs utilizing contact information, and of displaying the first image and the second image on a display module; a step of receiving a first operation with respect to the first image and a second operation with respect to the second image; and a step of activating the application program selected by the second operation, and of applying, to the activated application program, the contact information correlated to the contact object selected by the first operation, as contact information to be utilized in the activated application program, based on a determination that the first operation and the second operation are received.

### BRIEF DESCRIPTION OF THE DRAWINGS

These and other objects, and novel features of the present invention will become more apparent upon reading the following detailed description of the embodiment along with the accompanying drawings.

FIG. 1 is a diagram showing an external configuration of a mobile phone embodying the invention.

FIG. 2 is a block diagram showing an overall configuration of the mobile phone in the embodiment.

FIGS. 3A and 3B are respectively a table showing an example of contact information and a table showing an example of a correspondence list in the embodiment.

FIGS. 4A and 4B are respectively a flowchart showing an activation control processing and a diagram showing an execution screen of the activation control processing in the embodiment.

FIG. 5 is a flowchart showing a selection receiving processing routine in the embodiment.

FIGS. 6A and 6B are diagrams showing execution screens of the activation control processing in the embodiment, and FIG. 6C is a diagram showing an execution screen of an application activated based on the activation control processing in the embodiment.

FIGS. 7A and 7B are diagrams showing execution screens of the activation control processing in the embodiment, and FIG. 7C is a diagram showing an execution screen of an application activated based on the activation control processing.

FIG. 8 is a flowchart showing an activation control processing in a first modification.

FIG. 9 is a flowchart showing a selection receiving processing routine in the first modification.

FIGS. 10A and 10B are diagrams showing execution screens of the activation control processing in the first modification, and FIG. 10C is a diagram showing an execution screen of an application activated based on the activation control processing in the first modification.

FIGS. 11A and 11B are diagrams showing execution screens of the activation control processing in the first modification, and FIG. 11C is a diagram showing an execution screen of an application activated based on the activation control processing in the first modification.

FIGS. 12A and 12B are respectively a flowchart showing a selection receiving processing routine and a diagram showing an execution screen of an application activated based on an activation control processing in a second modification.

FIG. 13 is a flowchart showing a selection receiving processing routine in a third modification.

FIGS. 14A and 14B are diagrams showing execution screens of an activation control processing in the third modification, and FIG. 14C is a diagram showing an execution screen of an application activated based on the activation control processing in the third modification.

FIGS. 15A and 15B are diagrams showing execution screens of the activation control processing in the third modification, and FIG. 15C is a diagram showing an execution screen of an application activated based on the activation control processing in the third modification.

FIGS. 16A and 16B are diagrams showing execution screens of an activation control processing in another modification.

FIGS. 17A and 17B are diagrams showing execution screens of an activation control processing in another modification.

FIGS. 18A and 18B are respectively a diagram showing an execution screen of an activation control processing and a diagram showing an execution screen of an application activated based on the activation control processing in another modification.

FIGS. 19A and 19B are diagrams for describing a first operation and a second operation in another modification.

FIGS. 20A and 20B are flowcharts each showing a processing for activating an activation control processing in another modification.

The drawings are provided mainly for describing the present invention, and do not limit the scope of the present invention.

### DESCRIPTION OF PREFERRED EMBODIMENTS

In the following, an embodiment of the invention is described referring to the drawings.

In the embodiment, a storage module 12, an acquiring module 31, and a program executing module 34 correspond to an “executing module” in the claims. A correspondence list 23 corresponds to “correspondence information” in the claims. A contact icon 43 corresponds to a “first image” in the claims. An application icon 44 corresponds to a “second image” in the claims. The description regarding the correspondence between the claims and the embodiment is merely an example, and the claims are not limited by the description of the embodiment.

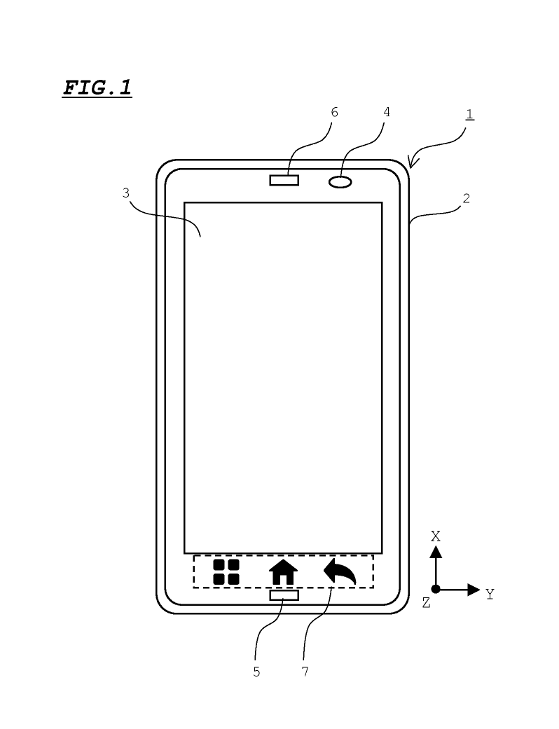

FIG. 1 is a front view showing an external configuration of a mobile phone 1. The mobile phone 1 is provided with a cabinet 2, a display surface 3, a lens window 4, a microphone 5, a speaker 6, and a key operation part 7.

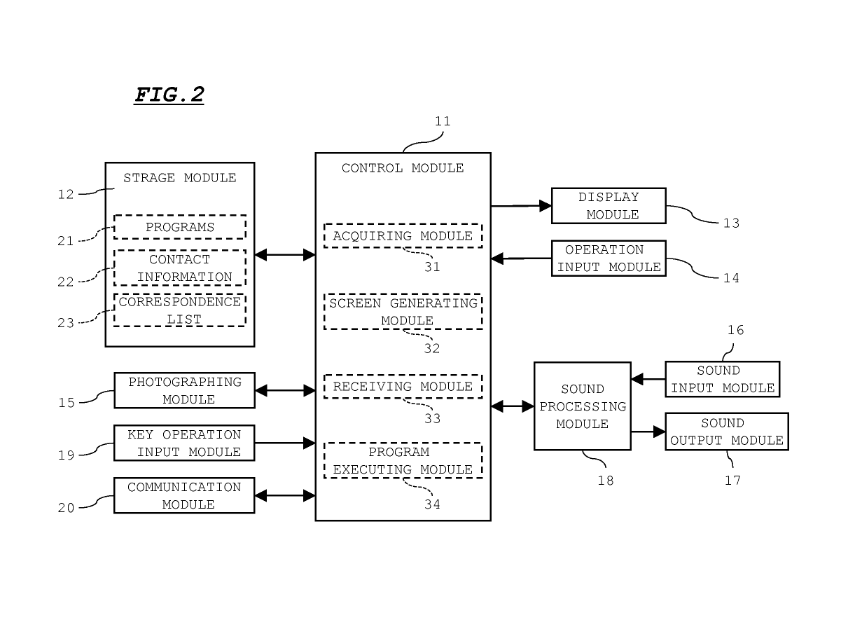

FIG. 2 is a block diagram showing the overall configuration of the mobile phone 1. The mobile phone 1 is provided with a control module 11, a storage module 12, a display module 13, an operation input module 14, a photographing module 15, a sound input module 16, a sound output module 17, a sound processing module 18, a key operation input module 19, and a communication module 20.

The display surface 3 is disposed on the front surface of the cabinet 2. The display surface 3 corresponds to a display plane of a display module 13. A screen is displayed on the display surface 3.

The lens window 4 is formed in such a manner as to face the front side of the cabinet 2, in other words, face the direction in which the DISPLAY surface 3 is disposed. An image of a subject facing the front side of the cabinet 2, such as the face of a user browsing a screen is captured by a photographing module 15 through the lens window 4.

The microphone 5 generates an electrical signal in accordance with an inputted sound. The generated electrical signal is outputted to the sound processing module 18. The speaker 6 outputs a sound in accordance with the electrical signal to be inputted from the sound processing module 18.

The key operation part 7 is provided on the cabinet 2. The key operation part 7 is composed of keys such as soft keys and hard keys. Various functions in accordance with a running program, etc., are assigned to the respective keys constituting the key operation part 7.

The storage module 12 is constituted of an ROM and an RAM, etc. The storage module 12 stores therein programs 21. The programs 21 are constituted of a control program for controlling the respective modules of the mobile phone 1, and other various applications such as a telephone application, an electronic mail application, a navigation application, a videophone application, an SMS (short message service) application, an SNS (social networking service) application, and a web browser application. The programs 21 also include programs for executing the functions of an acquiring module 31, a screen generating module 32, a receiving module 33, and a program executing module 34 to be described later.

The storage module 12 is also used as a working area which stores data to be temporarily used or generated in the course of executing the programs 21.

The control module 11 is constituted of a CPU, etc. The control module 11 executes various applications by controlling the modules constituting the mobile phone 1 such as the storage module 12, the display module 13, the operation input module 14, the photographing module 15, the sound input module 16, the sound output module 17, the sound processing module 18, the key operation input module 19, and the communication module 20 in accordance with the control program.

The display module 13 is constituted of a liquid crystal display, etc. The display module 13 displays a screen on the display surface 3, based on a control signal and an image signal from the control module 11. The display module 13 may be constituted of other display device such as an organic EL display, in place of a liquid crystal display.

The operation input module 14 is constituted of a touch sensor, etc., for detecting contact of an object such as a user's finger, a touch pen, and so on, (hereinafter, to simplify, referred to as a “finger”) with the display surface 3. The touch sensor is integrally formed with the liquid crystal display to thereby constitute a touch panel. The touch is formed into a transparent sheet-like member, and is disposed in such a manner as to cover the display surface 3.

The operation input module 14 receives user's input of touching the display surface 3 by a finger. The operation input module 14 detects a position on the display surface 3 where the finger has touched, as an input position; and outputs a position signal indicating the detected input position to the control module 11.

The user is allowed to perform various operations such as touching, tapping, sliding, and flicking on the display surface 3 by contacting the finger with the display surface 3. In the specification, “touching” is a operation of making contact the display surface 3 with the finger; “tapping” is a operation of touching the display surface 3 with the finger, followed by releasing the finger from the display surface 3; “flicking” is a operation of the display surface 3 with the finger (operation of touching the display surface 3 with the finger on the display surface 3 by a certain distance while keeping the finger in contact with the display surface 3, followed by releasing the finger from the display surface 3.

The touch sensor constituting the operation input module 14 may be any one of various types of touch sensors such as electrostatic capacitive sensors, ultrasonic sensors, pressure sensitive sensors, resistive sensors, and photosensitive sensors, etc.

The photographing module 15 is constituted of an imaging element such as a CCD or a CMOS sensor, etc., for sensing a light image entered through the lens window 4, an A/D conversion circuit which performs A/D conversion to a signal output from the imaging element, and a correction circuit which applies correction (such as gamma correction) to a signal which has undergone A/D conversion. The photographing module 15 transmits, to the control module 11, a digital signal representing an image, which has been generated by a photographing operation.

The photographing module 15 may be configured to photograph an image in a direction opposite to the direction of the display surface 3, in place of the above configuration or in addition to the above configuration.

The sound input module 16 is constituted of the microphone 5, etc. The sound input module 16 outputs an electrical signal from the microphone 5 to the sound processing module 18.

The sound output module 17 is constituted of the speaker 6, etc. The sound output module 17 inputs an electrical signal from the sound processing module 18, and outputs a sound from the speaker 6.

The sound processing module 18 performs A/D conversion, etc., to an electrical signal from the sound input module 16, and outputs a digital sound signal which has undergone A/D conversion to the control module 11. The sound processing module 18 performs decode processing and D/A conversion, etc., to a digital sound signal from the control module 11, and outputs an electrical signal which has undergone D/A conversion to the sound output module 17.

The key operation input module 19 outputs, to the control module 11, a signal corresponding to each key in response to user's depressing the keys in the key operation part 7.

The communication module 20 is provided with an antenna for transmitting/receiving radio wave for use in phone call or communication. The communication module 20 converts a signal for use in phone call or communication to be inputted from the control module 11 into a radio signal, and transmits the converted radio signal to a communication destination such as a base station or other communication device via the antenna. Further, the communication module 20 converts the radio signal received via the antenna into a signal of a format usable by the control module 11, and outputs the converted signal to the control module 11.

The storage module 12 stores therein contact information 22 and a correspondence list 23 (see FIG. 2).

The contact information 22 is information relating to contact destinations. The contact information 22 includes information of predetermined items such as names of contact objects such as persons or organizations, telephone numbers, electronic mail addresses, locations (residence addresses, etc.), connection information (e.g. URLs as connection destinations) for utilizing an SNS, and connection information (e.g. account names of connection destinations) for utilizing a videophone. The contact information 22 also includes information of other items such as facsimile numbers, IP phone numbers, and connection information for utilizing various on-line services (e.g. a chat service), in addition to the above.

The contact information 22 is generated based on execution of an application (an address book, etc.,) for registering/editing, etc., contact destinations. The contact information 22 may be generated based on information imported from an external source, etc. Contact information 22 with a plurality of items is correlated to each of the contact objects.

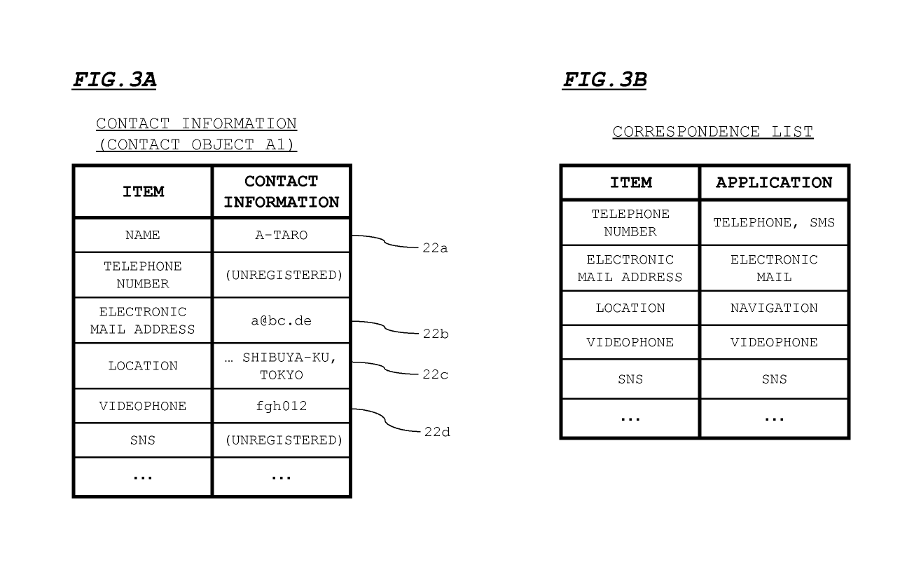

FIG. 3A is a table showing contact information 22 (pieces of contact information 22a through 22d) relating to a certain contact object A1. The pieces of contact information 22a through 22d are respectively information belonging to the items “name,” “electronic mail address,” “location” and “videophone.” The pieces of contact information 22a through 22d are stored in the storage module 12.

According to FIG. 3A, contact information, of the contact object A1, belonging to the items “telephone number” and “SNS” is not registered. In other words, contact information, of the contact object A1, belonging to the items “telephone number” and “SNS” is not stored in the storage module 12.

The storage module 12 stores a plurality of pieces of contact information 22 such as the aforementioned pieces of contact information 22a through 22d. In addition to the pieces of contact information 22a through 22d of the contact object A1, the storage module 12 is capable of storing a plurality of pieces of contact information 22 relating to other contact objects.

Hereinafter, in the description on the configuration relating to contact information, to simplify the description, in the case where contact information represents pieces of contact information in which items are specified, the reference signs 22a, 22b, 22c, . . . are given to the respective pieces of contact information; and in the case where contact information simply represents general contact information, the reference sign 22 is given to the contact information.

FIG. 3B is a table showing an example of the correspondence list 23. The correspondence list 23 is a list for indicating a correlation between an item of the contact information 22, and an application utilizing the contact information belonging to each of the items in executing each of the applications.

The item “telephone number” corresponds to a telephone application and an SMS application. The items “electronic mail address,” “location,” “videophone” and “SNS” respectively correspond to an electronic mail address application, a navigation application, a videophone application, and an SNS application.

These applications are activated by executing a predetermined activation function by a control module 11 (or the program executing module 34 to be described later). In the case where certain contact information 22 is selected as an argument of the activation function in executing the activation function, the control module 11 extracts the contact information 22 by a method in accordance with the application, and executes the application.

For instance, as contact information to be utilized in the telephone application, it is possible to apply to the telephone application, a telephone number (contact information 22) corresponding to the telephone application in the correspondence list 23. In this case, the control module 11 takes in the telephone number and executes the telephone application. For instance, the control module 11 executes a processing for allowing the user to make a phone call with a connection destination corresponding to the telephone number.

For example, as contact information to be utilized in the SMS application, it is possible to apply, to the SMS application, a telephone number (contact information 22) corresponding to the SMS application in the correspondence list 23. In this case, the control module 11 executes a processing for allowing the user to communicate via an SMS with a connection destination to be specified by the telephone number.

For instance, as contact information to be utilized in the electronic mail application, it is possible to apply, to the electronic mail application, an electronic mail address (e.g. contact information 22b) corresponding to the electronic mail application in the correspondence list 23. In this case, the control module 11 executes a processing for allowing the user to create and send a text message of an electronic mail to a person to be specified by the electronic mail address.

Another example is that as contact information to be utilized in the navigation application, it is possible to apply, to the navigation application, location information (e.g. contact information 22c) corresponding to the navigation application in the correspondence list 23. In this case, the control module 11 executes a processing for displaying, on the display surface 3, information related to a location point to be specified by the location information.

For instance, as contact information to be utilized in the videophone application, it is possible to apply, to the videophone application, connection information (e.g. contact information 22d) for utilizing a videophone, corresponding to the videophone application in the correspondence list 23. In this case, the control module 11 executes a processing for allowing the user to communicate via a videophone with a connection destination to be specified by the connection information.

For example, as contact information to be utilized in the SNS application, it is possible to apply, to the SNS application, connection information (contact information 22) for utilizing an SNS, corresponding to the SNS application in the correspondence list 23. In such a case, the control module 11 executes a processing for connecting to a connection destination to be specified by the connection information, and for utilizing the SNS based on the application.

For instance, as contact information to be utilized in another application for utilizing a predetermined on-line service, it is possible to apply, to another application for utilizing the predetermined on-line service, contact information 22 of a predetermined item, corresponding to the another application in the correspondence list 23. In this case, the control module 11 executes a processing for connecting to a connection destination to be specified by the applied contact information 22 based on the application, and for utilizing the on-line service based on the application.

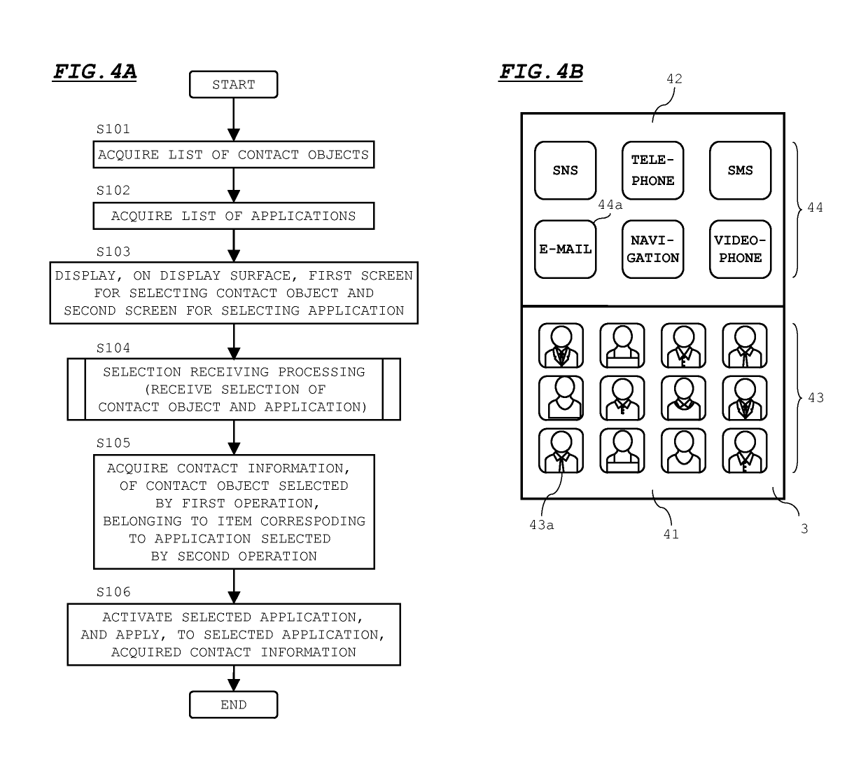

FIG. 4A is a flowchart showing an activation control processing. FIG. 4B is a diagram showing an execution screen of the activation control processing.

The control module 11 is provided with the acquiring module 31, the screen generating module 32, the receiving module 33, and the program executing module 34 for executing the activation control processing (see FIG. 2). The acquiring module 31 executes a processing of acquiring various information relating to the contact information 22, the applications, and the correspondence list 23 in executing the activation control processing. The screen generating module 32 executes a processing of generating images such as icons for configuring a screen such as an execution screen of the activation control processing including these images, and of displaying the configured screen on the display surface 3. The receiving module 33 executes a processing of receiving a user's operation with respect to a screen relating to the activation control processing. The program executing module 34 executes a processing of activating an application selected by the user.

In the following, the activation control processing is described referring to FIGS. 4A and 4B.

In Step S101, the acquiring module 31 acquires a list of contact objects, of which contact information 22 is registered.

In Step S102, the acquiring module 31 acquires a list of applications recorded in the correspondence list 23.

A list of contact objects may be created in advance and stored in the storage module 12, or may be generated each time the processing of Step S101 is executed by allowing the acquiring module 31 to read out the contact information 22 from the storage module 12. Likewise, a list of applications may be created in advance and stored in the storage module 12, or may be generated each time the processing of Step S102 is executed.

In Step S103, as shown in FIG. 4B, the screen generating module 32 configures an execution screen including a first screen 41 and a second screen 42, and displays the execution screen on the display surface 3. The screen generating module 32 configures the first screen 41 indicating a list of contact objects, based on the list of contact objects acquired by the acquiring module 31, and displays the first screen 41 on the display surface 3. The screen generating module 32 configures the second screen 42 indicating a list of applications, based on the list of applications acquired by the acquiring module 31, and displays the second screen 42 on the display surface 3.

The first screen is a screen for allowing the user to select one of a plurality of contact objects. The first screen includes, as an image configuring a list of contact objects, a plurality of icons (hereinafter, called as “contact icons”) 43 for allowing the user to select a contact object. The contact icons 43 shown in FIG. 4B are constituted of twelve contact icons 43 including a contact icon 43a corresponding to the contact object A1 shown in FIG. 3A.

The second screen is a screen for allowing the user to select one of a plurality of applications. The second screen includes, as an image configuring a list of applications, a plurality of icons (hereinafter, called as “application icons”) 44 for allowing the user to select an application. For instance, an application icon 44a indicating the electronic mail application corresponding to the item “electronic mail address” constitutes one of the application icons 44.

In Step S104, the receiving module 33 executes a selection receiving processing of receiving a user's operation (hereinafter, called as “first operation”) with respect to the first screen, and receiving a user's operation (hereinafter, called as “second operation”) with respect to the second screen.

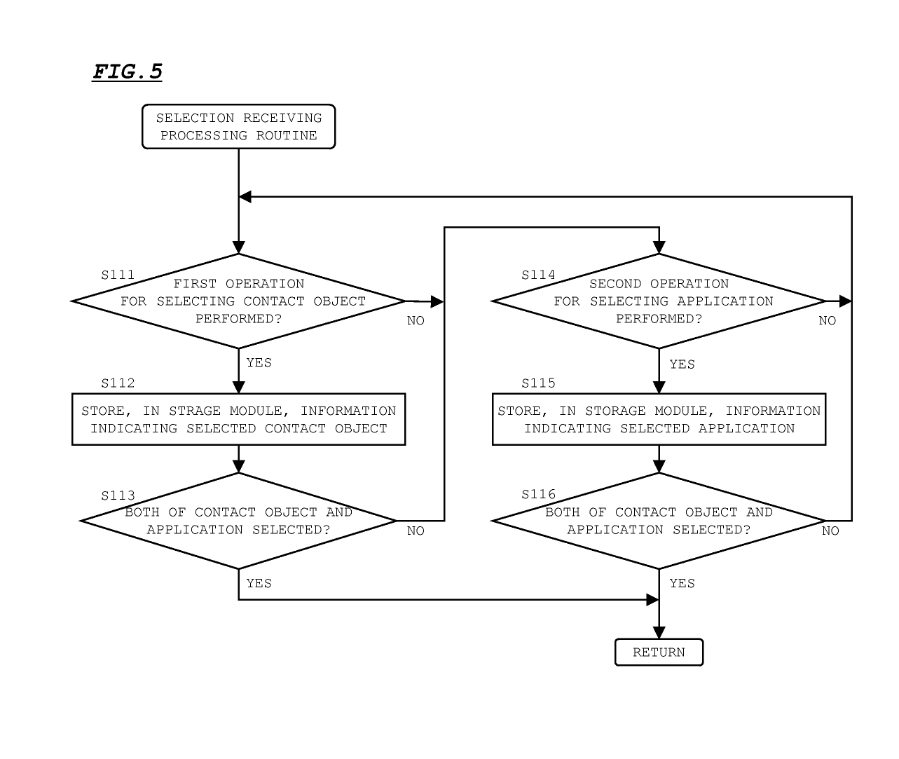

FIG. 5 is a flowchart showing a selection receiving processing routine. The selection receiving processing routine represents the contents of the selection receiving processing of Step S104.

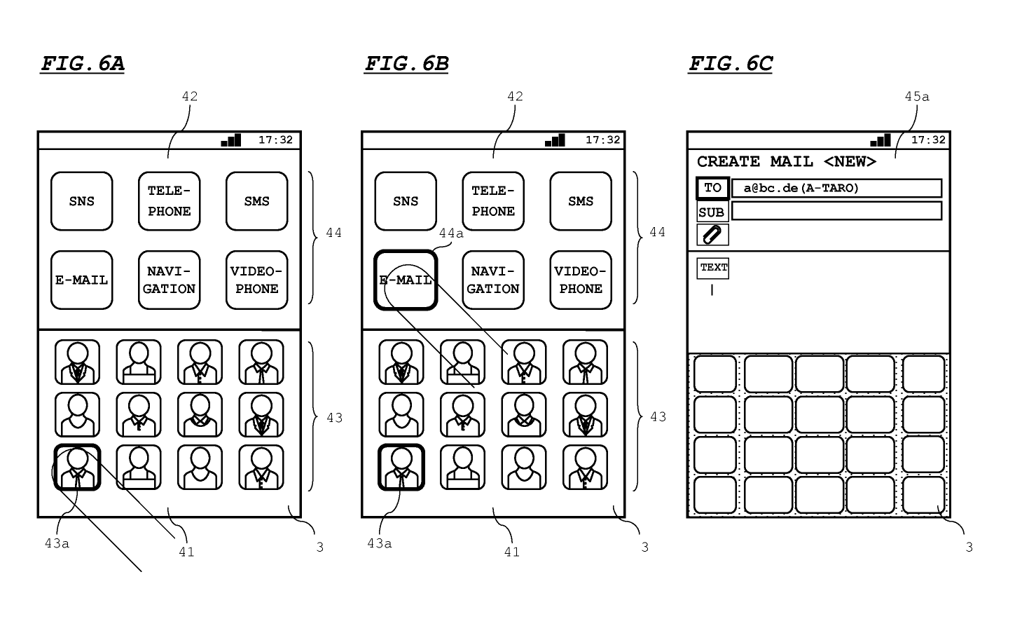

FIGS. 6A and 6B are diagrams showing execution screens of the activation control processing in executing the selection receiving processing routine.

In the selection receiving processing routine, the receiving module 33 determines whether the first operation for selecting a contact object is performed or not (S111). In the case where the operation input module 14 detects a user's operation (touching) for selecting one of the contact icons 43 in a region where the first screen 41 is displayed, the receiving module 33 determines that the first operation for selecting a contact object is performed (S111: YES). In this case, the receiving module 33 specifies the touched contact icon 43, based on a position signal from the operation input module 14, and determines that a contact object corresponding to the specified contact icon 43 is selected. Then, the receiving module 33 stores, in the storage module 12, information indicating the selected contact object (S112). The information indicating a contact object is utilized in the processings of Step S105 and Step S106 (see FIG. 4A) to be described later. In the case where the operation input module 14 does not detect a user's operation for selecting one of the contact icons 43, the receiving module 33 proceeds to the processing of Step S114 to be described later.

For instance, as shown in FIG. 6A, in the case where the contact icon 43a is touched (S111: YES), information indicating the contact object A1 corresponding to the touched contact icon 43a is stored in the storage module 12 (S112).

During execution of the selection receiving processing routine shown in FIG. 5, the control module 11 may execute a processing of displaying, on the display module 13, contact information 22 corresponding to a contact icon 43, targeted by a predetermined operation based on the predetermined (e.g., a long-tapping operation of the contact icon 43) different from the first operation.

After the information indicating a contact object is stored in the storage module 12, the receiving module 33 determines whether both of a contact object and an application are selected or not (S113). In the case where the information indicating a contact object and the information indicating an application are stored in the storage module 12 based on the processings of Step S112 and Step S115 (to be described later) (S113: YES), the receiving module 33 terminates the selection receiving processing routine, based on an assumption that the user has selected both of a contact object and an application.

The user is allowed to perform the first operation for selecting a contact object with respect to the first screen a number of times. In this case, selection of a contact object based on the first operation at a previous time and before that is cancelled. The receiving module 33 updates the information indicating a contact object stored in the storage module 12 into information indicating a newly selected contact object (S112), based on the first operation (S111: YES) for selecting the newly selected contact object.

After the updating, in the case where an application is not yet selected, regardless of the selection of a contact object (S113: NO), the receiving module 33 proceeds to the processing of Step S114.

In Step S114, the receiving module 33 determines whether the second operation for selecting an application is performed or not. In the case where the operation input module 14 detects a user's operation for selecting one of the application icons 44 in a region where the second screen 42 is displayed, the receiving module 33 determines that the second operation for selecting an application is performed (S114: YES). In this case, the receiving module 33 specifies the touched application icon 44 based on a position signal from the operation input module 14, and stores, in the storage module 12, the information indicating the application corresponding to the specified application icon 44 (S115). The information indicating an application is utilized in the processings of Step S105 and Step S106 to be described later.

For instance, as shown in FIGS. 6A and 6B, in the case where the contact icon 43a is touched, and subsequently, the application icon 44a is touched (S114: YES), the information indicating the contact icon 43a whose selection is received and the information indicating the electronic mail application whose selection is received are stored in the storage module 12 (S115).

The control module 11 monitors the information indicating a contact object stored in the storage module 12 based on the processing of Step S112, or the information indicating an application stored in the storage module 12 based on the processing of Step S115, during execution of the selection receiving routine, for notifying the user of a selection state on a contact object and an application. In the case where the control module 11 detects that the information indicating a contact object or the information indicating an application is stored in the storage module 12, the screen generating module 32 highlights (increases the saturation or enlarges the image), the selected contact icon 43a and the selected application icon 44a, as schematically shown in FIG. 6A or FIG. 6B.

The processing for notifying the user of a selection state on a contact object and an application is not limited to the highlight display of an icon (contact icon 43 and application icon 44), and is also not limited to a processing to be performed by the screen generating module 32. The processing for notifying the user of a selection state on a contact object and an application may be performed by various means for notifying that a user's operation for selecting a contact object is received, such as a visual effect different from highlight display, a notification of a message by text, or a notification by vibration or sound, etc. The processing for notifying the user of receiving a user's selection, such as highlight display, etc., may be omitted.

After the information indicating an application is stored in the storage module 12, the receiving module 33 determines whether both of a contact object and an application are selected substantially in the same manner as the processing of Step S113 or not (S116). In the case where both of a contact object and an application are selected (S116: YES), the receiving module terminates the processing of the selection receiving processing routine (see FIG. 5 and FIG. 4A). In the case where a contact object is not selected (S116: NO), the receiving module 33 executes the processing of Step S111.

In Step S115, in the case where the second operation for selecting an application is detected a plurality of times, the receiving module 33 updates the information indicating an application stored in the storage module 12 as necessary substantially in the same manner as the processing of Step S112.

After the execution of the selection receiving processing (selection receiving processing routine) of Step S104 is completed, the acquiring module 31 acquires the contact information 22 (S105), of the contact object selected by the first operation, which belongs to the item corresponding to the application selected by the second operation.

Specifically, the acquiring module 31 reads in the information indicating an application stored in the storage module 12 (see Step S115), and specifies the item corresponding to the application based on the correspondence list 23. Then, the acquiring module 31 specifies the contact object selected by the first operation, based on the information indicating a contact object stored in the storage module 12 (see Step S112), and acquires the contact information 22 belonging to the specified item of the contact object.

For instance, in the case of the example shown in FIGS. 6A and 6B, the acquiring module 31 acquires contact information 22b “a@bc.de,” which belongs to the item “electronic mail address,” of the contact object A1 (see FIG. 3A) corresponding to the contact icon 43a (S105).

After the acquiring module 31 acquires the contact information 22, the program executing module 34 executes the selected application, and applies, to the application, the selected contact information 22, as contact information to be utilized in the application (S106). After the application is executed, the activation control processing shown in FIG. 4A is terminated.

FIG. 6C is a diagram showing an execution screen of an application activated by the activation control processing. The program executing module 34 applies, to the electronic mail application, the electronic mail address “a@bc.de,” which is the contact information 22b, based on the selection operation as exemplified in FIGS. 6A and 6B. As a result of the above operation, as shown in FIG. 6C, an execution screen 45a of the electronic mail application is displayed on the display surface 3 for allowing the user to send an electronic mail to the contact information 22b.

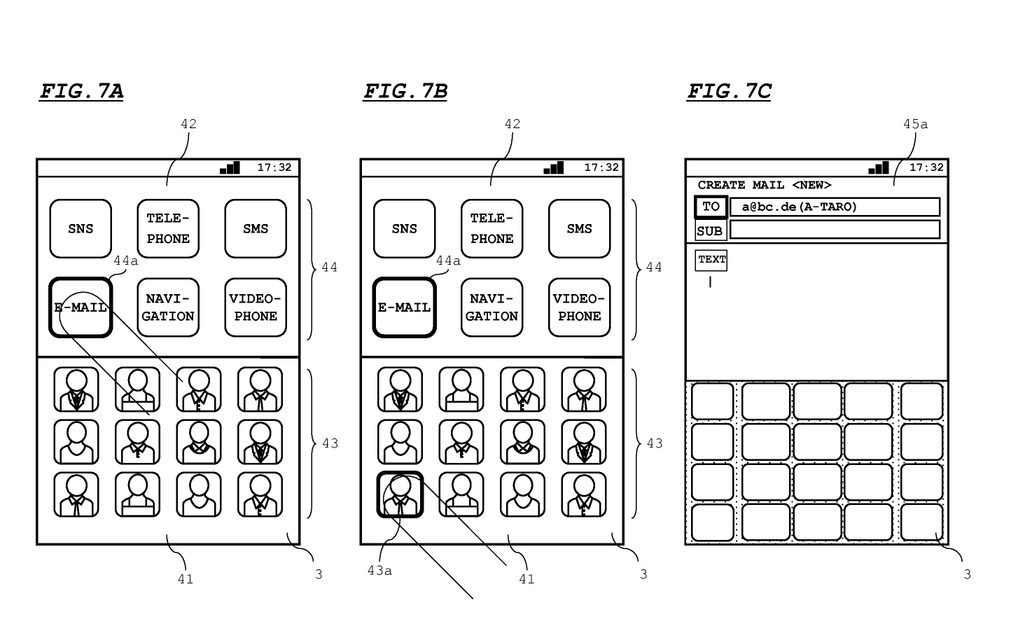

FIGS. 7A and 7B are diagrams showing execution screens of the activation control processing in executing the selection receiving processing routine. FIG. 7C is a diagram showing an execution screen of an application activated by the activation control processing.

In the example shown in FIGS. 6A through 6C, the second operation is performed after the first operation. Conversely to the above, as shown in FIGS. 7A and 7B, in the case where the first operation is performed after the second operation, the receiving module 33 is also operable to receive the first operation and the second operation. In other words, the receiving module 33 receives the second operation (see FIG. 7A) for selecting the electronic mail application (S114: YES→Step S115), and then, receives the first operation (see FIG. 7B) for selecting the contact object A1 (S111: YES→Step S112). In this case, the processings of Step S105 and Step S106 are executed substantially in the same manner as the example shown in FIGS. 6A through 6C. As a result of the above operation, as shown in FIG. 7C, the control module 11 displays, on the display surface 3, an execution screen 45a of the electronic mail application for allowing the user to send an electronic mail to the contact information 22b.

In the case where contact information belonging to an item corresponding to an application selected in the selection receiving processing routine is not registered in the storage module 12 as contact information of a selected contact object, the acquiring module 31 is inoperative to acquire contact information (S105), and the program executing module 34 is inoperative to apply contact information to a selected application (S106). For instance, in the example shown in FIG. 3A, contact information belonging to the items “telephone number” and “SNS” is not registered as contact information of the contact object A1. For example, in the case where the telephone application is selected by the second operation, the program executing module 34 executes the telephone application without applying, to the telephone application, a telephone number (contact information 22 of the item “telephone number”).

In the case where contact information belonging to an item corresponding to an application selected in the selection receiving processing routine is not registered as contact information of a selected contact object, it may be configured to cancel activation of an application in Step S106.

As described above, according to the embodiment, an application is executed based on a determination that both of the first operation for selecting a contact icon 43 corresponding to a contact object such as a person or an organization, and the operation for selecting an application icon 44 corresponding to an application are received. In executing an application, contact information 22 of a selected contact object is applied to the executed application, as contact information to be utilized in the executed application. The user is allowed to activate an application utilizing the contact information by a simplified operation for selecting an intended combination of a contact object and an application, while viewing a Plurality of contact icons 43 and a Plurality of application icons 44. Thus, the user is allowed to smoothly activate various applications.

Further, according to the embodiment, the acquiring module 31 acquires contact information 22 to be utilized in the application, based on a contact object and the application, each of which is selected by the user. Therefore, it is not necessary for the user to select the contact information 22. This simplifies the user's operation.

Furthermore, according to the embodiment, it is possible to execute the above application, regardless of the order of the first operation for selecting a contact object and the second operation for selecting the application. The user is allowed to select a contact object and an application without following the procedure of a predetermined sequence of operations (e.g. operations of opening an address book, selecting contact information by a predetermined procedure further activating an application).

### First Modification

As described in the first modification, an activation control processing may be configured to receive a user's selection of a plurality of contact objects or a plurality of applications.

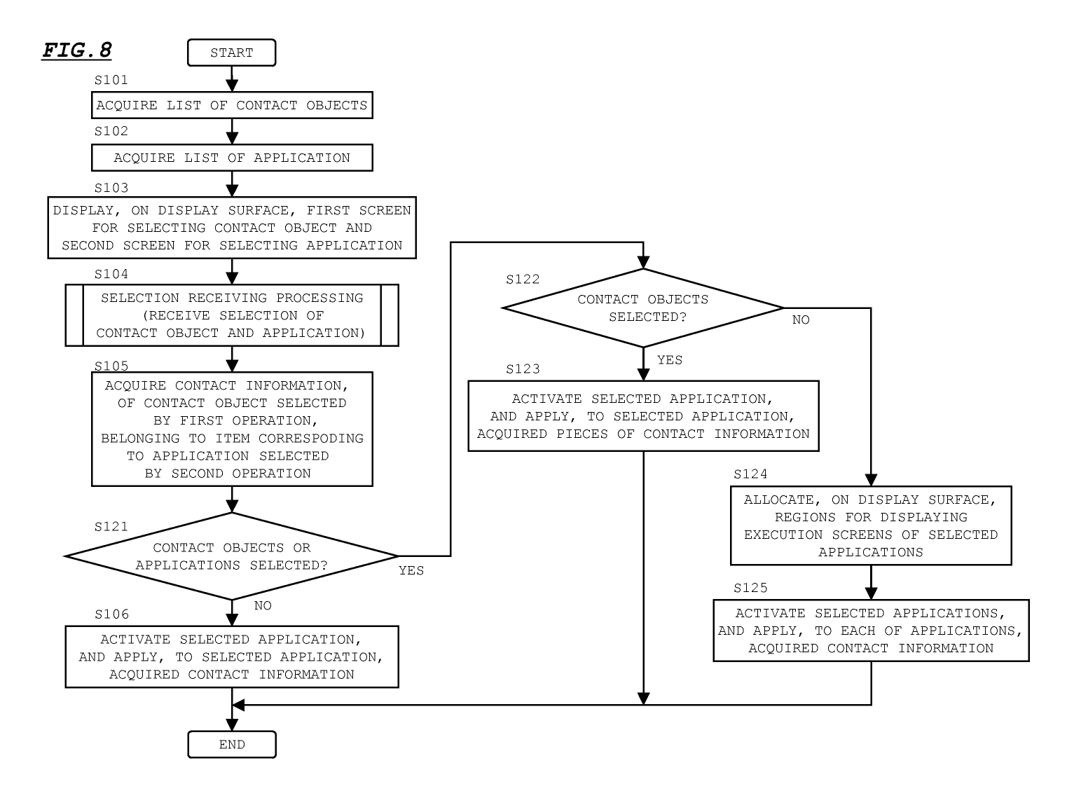

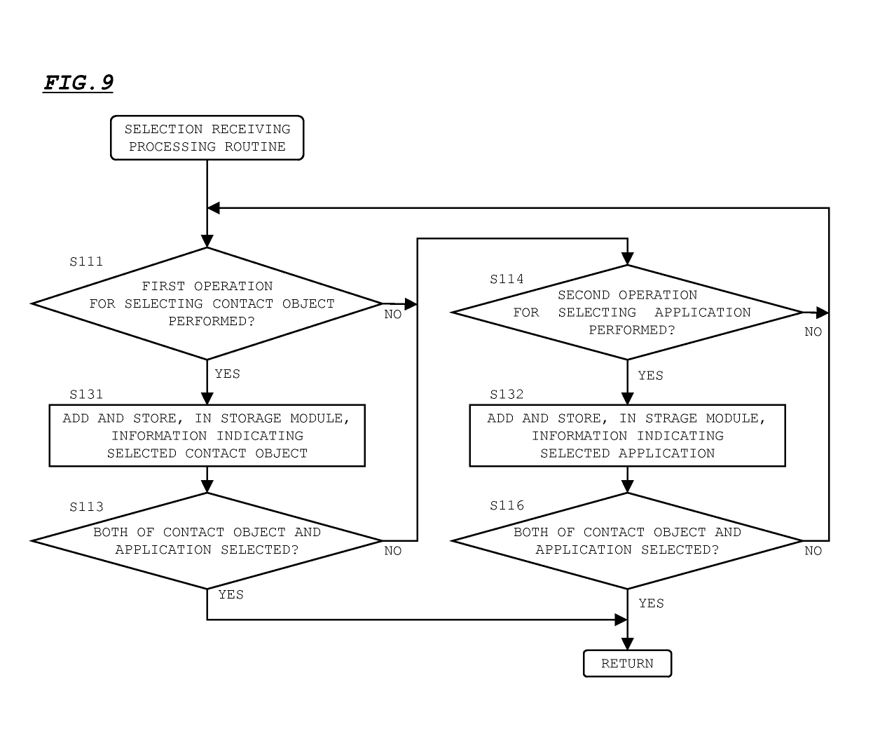

FIG. 8 is a flowchart showing the activation control processing in the first modification. FIG. 9 is a flowchart showing a selection receiving processing routine in the first modification.

Referring to the flowchart shown in FIG. 8, unlike the flowchart shown in FIG. 4A, the processing of Step S121 is inserted between Step S105 and Step S106, and the processings of Steps S122 through S125 are further added. The processings of Steps S121 through S125 are executed by a program executing module 34.

The flowchart shown in FIG. 9 is such that the processings of Step S112 and Step S115 in the flowchart shown in FIG. 5 are respectively replaced by the processings of Step S131 and Step S132 to be executed by a receiving module 33.

In Step S104 of the activation control processing shown in FIG. 8, the selection receiving processing routine shown in FIG. 9 is executed. The processing of Step S131 is substantially the same as the above processing of Step S112 in the embodiment (see FIG. 5), in the case where the processing of Step S131 is executed for the first time after start of execution of the selection receiving processing routine.

In the case where the processing of Step S131 is executed for the second time and thereafter, unlike the processing of Step S112, the receiving module 33 adds and stores, in a storage module 12, a newly selected contact object. In other words, in Step S131, the receiving module 33 holds information indicating a contact object which is stored in the storage module 12 based on a previously executed processing of Step S131, without erasing the information.

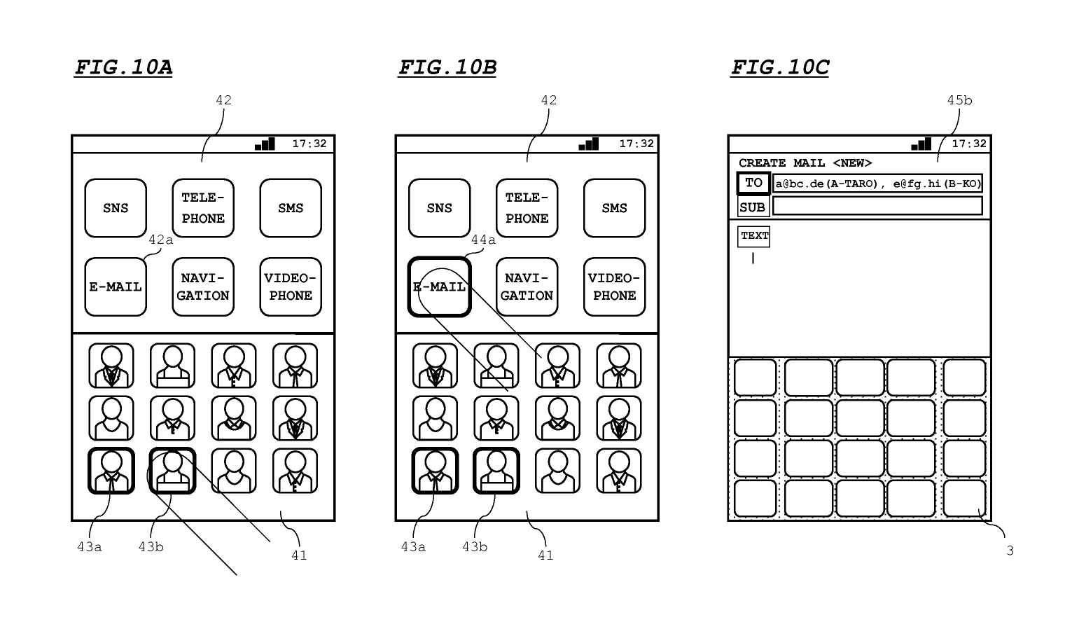

FIGS. 10A and 10B are diagrams showing execution screens of the activation control processing. FIG. 10C is a diagram showing an execution screen of an application activated based on the activation control processing.

As shown in FIG. 10A, the first operation for selecting a contact object A1 corresponding to a contact icon 43a is performed, and thereafter, the first operation for selecting a contact object A2 corresponding to a contact icon 43b is allowed. In this case, at the time of executing the processing of Step S131 for the second time, the receiving module 33 adds and stores, in the storage module 12, the information indicating the contact object A2 that is selected for the second time, without erasing the information indicating the contact object A1 that has already been stored in the storage module 12. Thereafter, as shown in FIG. 10B, in the case where a second operation for selecting an electronic mail application is performed (S114: YES), the receiving module 33 determines that both of a contact object and an application are selected (S116: YES), and terminates the execution of the selection receiving processing routine. At the time of terminating the execution of the selection receiving processing routine, the information indicating the contact object A1 and the information indicating the contact object A2 are stored in the storage module 12.

In Step S121, the program executing module 34 determines whether a plurality of contact objects or a plurality of applications are selected or not. In the case of the example shown in FIGS. 10A and 10B, the program executing module 34 determines that a plurality of contact objects are selected (S121: YES→S122: YES), and applies, to the electronic mail application, acquired pieces of contact information, i.e., the electronic mail addresses (contact information 22) of the contact objects A1 and A2 (S123).

As shown in FIG. 10C, a control module 11 displays, on a display surface 3, an execution screen 45b for allowing the user to create and send a text message of an electronic mail to two recipients to be specified by the electronic mail addresses.

In the processing of Step S132, the receiving module 33 adds and stores, in the storage module 12, information indicating a selected application substantially in the same manner as Step S131. In other words, in the case where the processing of Step S132 is executed for the first time after start of execution of the selection receiving processing routine, the receiving module 33 executes a substantially same processing as the processing of Step S115 (see FIG. 5), and in the case where the processing of Step S132 is executed for the second time and thereafter, the receiving module 33 adds and stores, in the storage module 12, a newly selected contact object substantially in the same manner as the processing of Step S131.

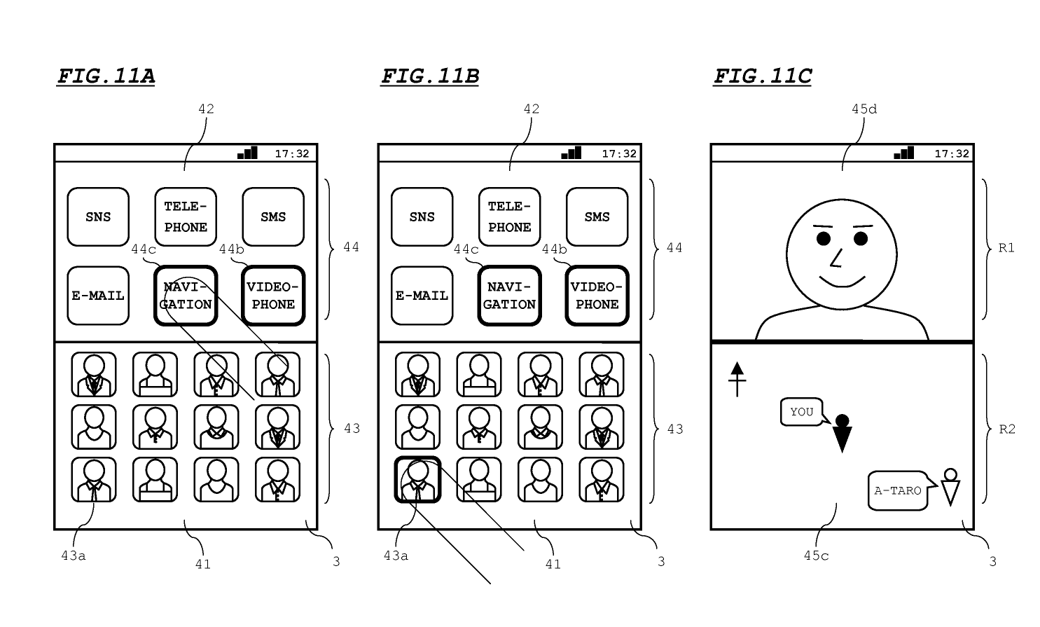

FIGS. 11A and 11B are diagrams showing execution screens of the activation control processing in the first modification. FIG. 11C is a diagram showing an execution screen of an application activated based on the activation control processing.

As shown in FIG. 11A, after the second operation for selecting a videophone application corresponding to an application icon 44b is performed, the second operation for selecting a navigation application corresponding to an application icon 44c can be allowed. In this case, the receiving module 33 stores, in the storage module 12, two pieces of information, i.e., information indicating a videophone application and information indicating a navigation application by executing the processing of Step S132 twice (S132).

Thereafter, as shown in FIG. 11B, in the case where the first operation for selecting a contact icon 43a is performed (S111: YES), the receiving module 33 determines that both of a contact object and an application are selected (S113: YES), and terminates the execution of the selection receiving processing routine.

In the above example, the program executing module 34 determines that a plurality of applications are selected (S121: YES→S122: NO), and allocates, on the display surface 3, two regions R1 and R2 corresponding to execution screens of the selected two respective applications for displaying the execution screens (S124). The region R1 is allocated for displaying the execution screen of the videophone application, and the region R2 is allocated for displaying the execution screen of the navigation application.

After the regions for displaying the execution screens are allocated, the program executing module 34 activates the selected two applications, and applies, to each of the applications, contact information of a selected contact object, i.e., acquired contact information (S125). As a result of the above operation, as shown in FIG. 11C, an execution screen 45c of the videophone application is displayed in the region R1. For instance, a communication partner answering a videophone call is displayed in the region 1. Further, an execution screen 45d of the navigation application is displayed in the region R2. For instance, a map indicating the location of the contact destination is displayed in the region 2.

In the case where one contact object and one application are selected (S121: NO), the program executing module 34 executes the processing of above Step S106.

In the case where three or more applications are selected by the second operation, the program executing module 34 allocates, on the display surface 3, regions of the same number as the number of the selected applications, and displays each of the execution screens in each of the regions.

As described above, in the configuration of the first modification, in the case where the first operation for selecting a plurality of contact objects is received, contact information 22 of the contact objects is applied to an application selected by the second operation.

Conventionally, in the case where a plurality of pieces of contact information are applied to one application, the user is required to select contact destinations for the same number of times as the number of the contact destinations. Such multiple selections as described above is cumbersome to the user. In contrast, in the configuration of the first modification, the user is only required to select an intended number of contact icons 43 for applying a plurality of pieces of contact information 22 to one application. This simplifies the user's operation.

Further, in the configuration of the first modification, in the case where the second operation for selecting a plurality of applications is received, contact destinations of contact objects selected by the first operation are applied to each of the applications.

Conventionally, the user is required to activate each of the applications individually in activating the applications. Further, the user is required to select contact information by a procedure in accordance with each of the applications for applying the contact information to each of the applications. Such an operation is cumbersome to the user. In contrast, in the configuration of the first modification, the user is only required to select intended application icons 44 with respect to a second screen including the application icons 44 for applying the contact information 22 to each of the applications. This simplifies the user's operation.

The program executing module 34 may be configured to display, on the display surface 3, a predetermined execution screen among the execution screens of applications, without displaying the rest of the execution screens. In the above modification, the program executing module 34 executes the applications in a non-display state, as a background processing. Thus, the user is allowed to browse the execution screen of the application displayed in a wide display area, unlike a configuration in which all the execution screens are displayed in the display surface 3.

### Second Modification

In the configuration of the first modification, in the case where a plurality of contact objects are selected by the first operation, contact information 22 of the contact objects is utilized for execution of one application selected by the second operation. As a further modification, as will be described in the second modification, in the case where a plurality of contact objects are selected by the first operation, it may be configured to activate applications identical to a certain application selected by the second operation, by the same number as the number of the selected contact objects.

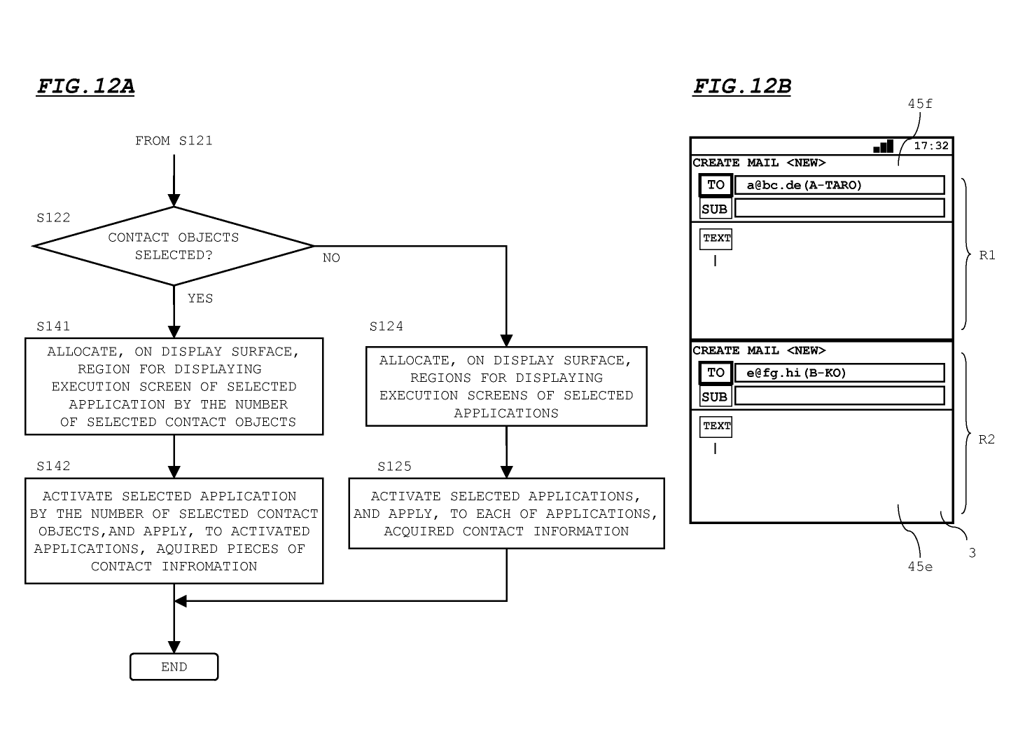

FIG. 12A is a flowchart showing an activation control processing in the second modification. FIG. 12B is a diagram showing an execution screen of an application activated based on the activation control processing in the second modification.

A selection receiving processing routine in the second modification is substantially the same as the selection receiving processing routine in the first modification (see FIG. 9).

Unlike the flowchart shown in FIG. 8, the flowchart shown in FIG. 12A is such that the processing of Step S123 is replaced by the processings of Step S141 and Step S142. In the flowchart shown in FIG. 12A, illustration of the processings of steps substantially equivalent to the steps of the flowchart shown in FIG. 8 is omitted.

In the case where the first operation and the second operation shown in FIGS. 10A and 10B are performed, selection of two contact objects A1 and A2 is received, and then, selection of an electronic mail application is received by the selection receiving processing of Step S104. In this case, in Step S141, a program executing module 34 allocates, on a display surface 3, an region for displaying an execution screen of the selected application by the same number as the number of the selected contact objects. In the example shown in FIG. 12B, regions R1 and R2 respectively corresponding to the selected two contact objects A1 and A2 are allocated on the display surface 3.

After the allocation of the regions, the program executing module 34 activates the selected application twice, and applies, to the activated two applications, the contact information 22 of the selected two contact objects (S142). As a result of the above operation, two execution screens 45e and 45f of the electronic mail application are respectively displayed in the two regions R1 and R2 in a state that the contact information is individually applied to the activated applications (see FIG. 12B).

As described above, in the configuration of the second modification, contact information 22 of selected contact objects is individually applied to a plurality of applications activated by selecting one application icon 44. Thus, the user is allowed to activate a group of identical applications (e.g., electronic mail applications) corresponding to respective contact information 22 of a plurality of contact objects by selecting one application icon 44.

### Third Modification

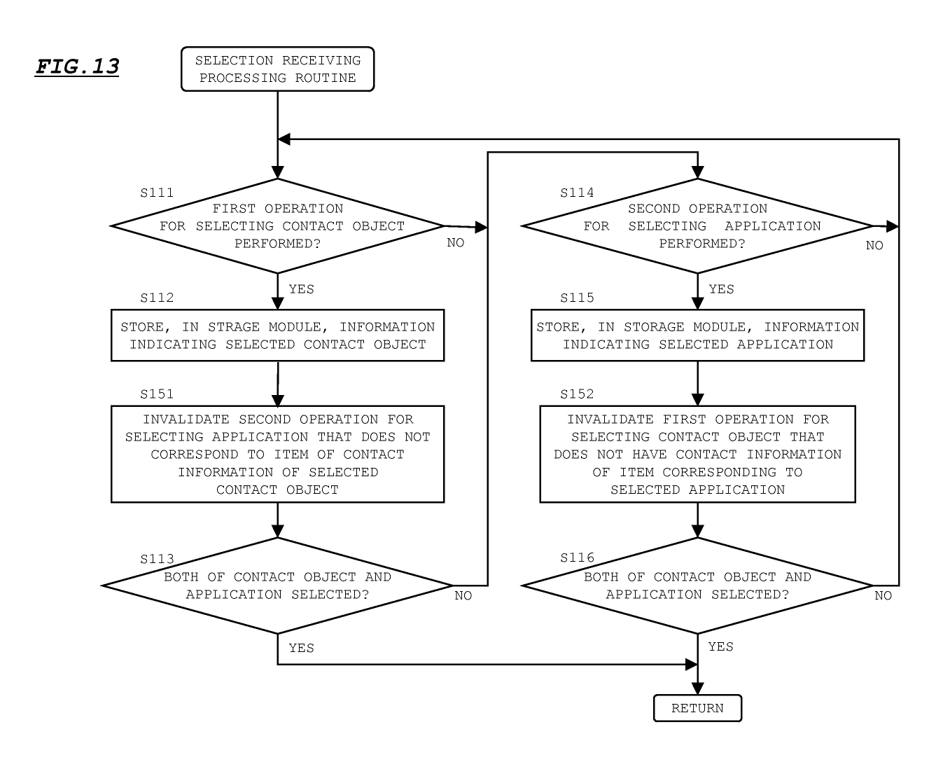

FIG. 13 is a flowchart showing a selection receiving processing routine in the third modification. Referring to the flowchart shown in FIG. 13, unlike the flowchart showing the selection receiving processing routine in the embodiment (FIG. 5), the processing of Step S151 is inserted between Step S112 and Step S113, and the processing of Step S152 is inserted between Step S115 and Step S116.

In Step S151, a receiving module 33 invalidates the second operation for selecting an application incapable of utilizing contact information 22 of a selected contact object, i.e., the application which is not correlated to contact information of a selected contact object with a correspondence list 23. By invalidating the selection, in the case where a user's operation of touching an application icon 44 corresponding to an application whose selection is invalidated, the processing of Step S114 is determined to be NO.

In the example shown in FIG. 3A, the unregistered items for a selected contact object are “telephone number” and “SNS.” In this case, the receiving module 33 invalidates selection, by the second operation, of a telephone application and an SMS application corresponding to the item “telephone number,” and of the SNS application corresponding to the item “SNS” (S151).

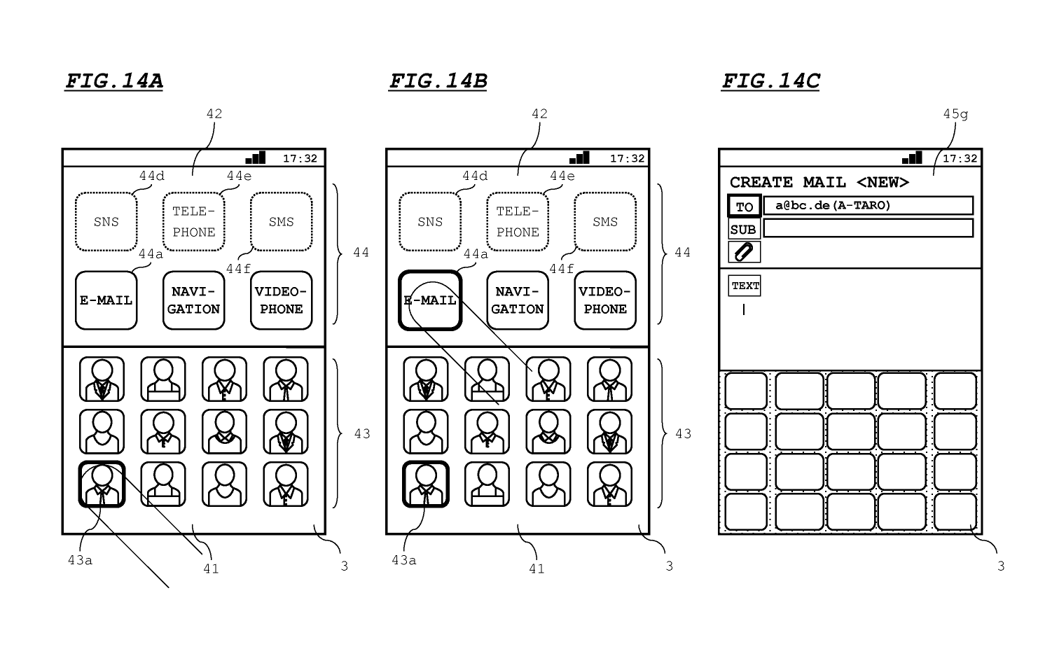

FIGS. 14A and 14B are diagrams showing execution screens of an activation control processing in the third modification. FIG. 14C is a diagram showing an execution screen of an application activated based on the activation control processing in the third modification.

A control module 11 monitors whether selection by the second operation is in a valid state, or selection by the second operation is in an invalid state, as a result of the processing of Step S151 with respect to each of the applications. In the case where the control module 11 detects an application whose selection is invalidated, a screen generating module 32 decreases the saturation of the display of an application icon corresponding to the invalidated application. In the example shown in FIG. 14A, three application icons 44d, 44e, and 44f corresponding to the telephone application, the SMS application, and the SNS application are displayed in a state that the saturation of the application icons is decreased. In the case where a user's operation of touching the invalidated application icons 44d, 44e or 44f is detected, the receiving module 33 determines the determination processing of Step S114 shown in FIG. 13 to be NO.

Application icons 44a, 44b and 44d corresponding to applications whose selection is not invalidated are displayed in an ordinary state. As illustrated by the example shown in FIG. 14B, in the case where a user's operation of touching the electronic mail application icon 44a whose selection is validated is detected, the determination processing of Step S114 is determined to be YES. As a result of the above operation, an execution screen 45g of the electronic mail application is displayed on a display surface 3 (see FIG. 14C).

In the processing of Step S152, the receiving module 33 invalidates the first operation for selecting a contact object that does not have contact information usable by a selected application, i.e., a contact object that does not have contact information of an item corresponding to the application in the correspondence list 23 substantially in the same manner as the processing of Step S151.

The screen generating module 32 decreases the saturation of a contact icon corresponding to a contact object whose selection is invalidated as the same with the case where the processing of Step S151 is performed.

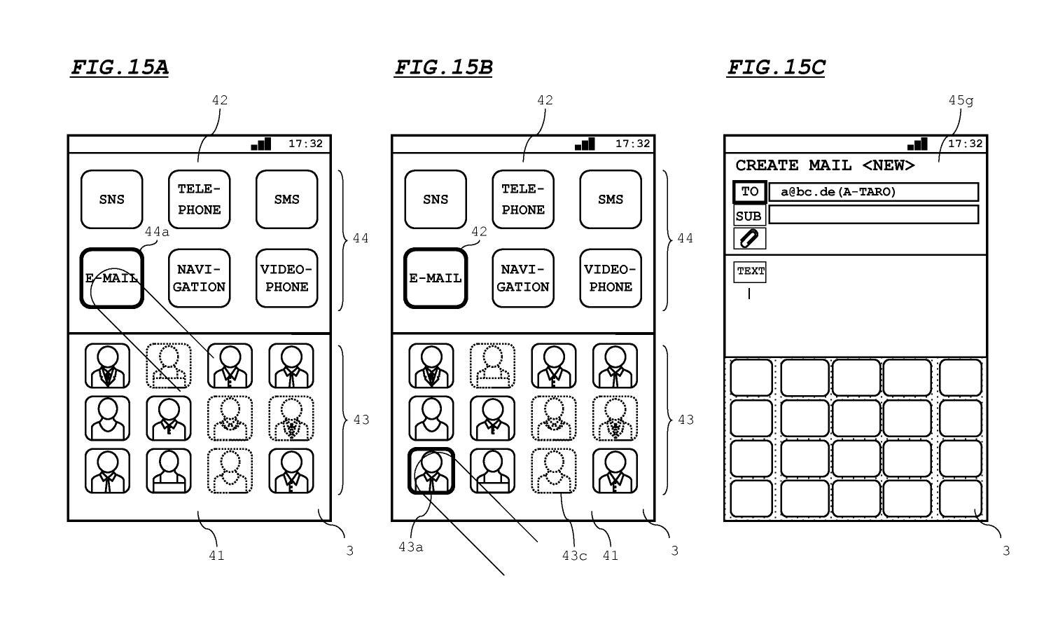

FIGS. 15A and 15B are diagrams showing execution screens of the activation control processing in the third modification. FIG. 15C is a diagram showing an execution screen of an application activated based on the activation control processing in the third modification.

As shown in FIG. 15A, in the case where an electronic mail application is selected by the second operation, the receiving module 33 invalidates selection of a contact object that does not have contact information of the item “electronic mail address” corresponding to the electronic mail application.

In the configuration of FIG. 3A, the contact information 22b of the contact object A1 is registered as contact information belonging to the item “electronic mail address.” Accordingly, after selection of the application icon 44a, the first operation for selecting the contact object A1 is validated (see FIG. 15B). In the case where the contact object A1 is selected, the execution screen 45g of the electronic mail application, which is a screen for allowing the user to send an electronic mail to the selected contact object A1, is displayed on the display surface 3 (see FIG. 15C).

For instance, in the case where a user's operation of touching an invalidated contact icon 43c (see FIG. 15B) is detected, the receiving module 33 determines the determination processing of Step S111 to be NO.

There is a case that a contact object does not have contact information of a certain item. In the example shown in FIG. 3A, the contact object A1 does not have contact information belonging to the items “telephone number” and “SNS.” Accordingly, the second operation for selecting a telephone application is invalidated in a state that the contact object A1 is selected.

As described above, in the configuration of the third modification, the user is allowed to easily select an application capable of using contact information 22 of a selected contact object, or a contact object having contact information 22 usable by a selected application.

In the third modification, the saturation of an icon (contact icon 43 and application icon 44) whose selection is invalidated is decreased. The configuration is not limited to the above. Alternatively, it may be configured to notify whether selection of an icon is allowed or not (validated or invalidated) by various means. For example, it is possible to highlight an icon (contact icon 43 and application icon 44) whose selection is validated.

### Others

The embodiment and the modifications of the invention have been described as above. The invention is not limited to the foregoing embodiment and modifications, and the embodiment of the invention may be modified in various ways other than the above.

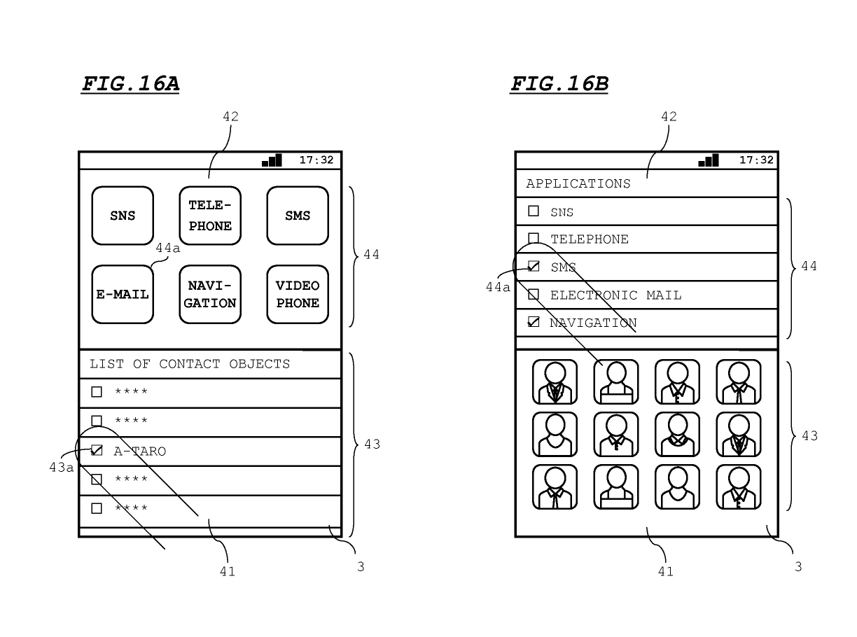

In the embodiment and the first through third modifications, a list of contact objects is displayed on the first screen 41 by a plurality of contact icons 43, and a list of applications is displayed on the second screen 42 by a plurality of application icons 44. Alternatively, as shown in FIG. 16A, checkboxes may be displayed in place of the contact icons 43, and as shown in FIG. 16B, checkboxes may be displayed in place of the application icons 44. In the aforementioned examples, a operation of checking a checkbox corresponds to the first operation or the second operation. Further alternatively, both of the list of contact objects and the list of applications may be displayed in the form of a table with checkboxes.

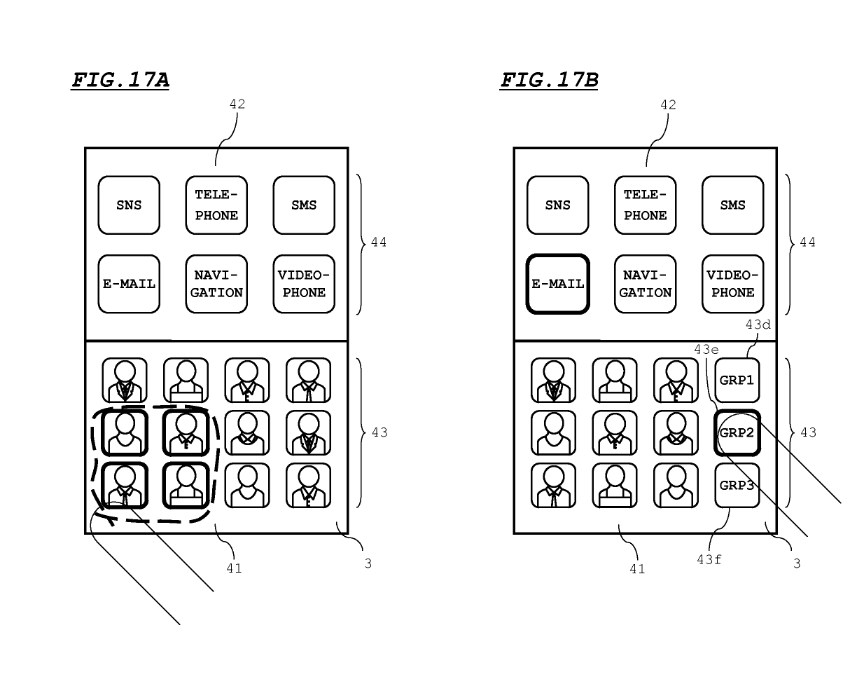

A user's operation (first operation, second operation) for selecting a contact object or an application may include various operations such as a operation of circling one or more contact icons by sliding the finger on a display surface 3, as shown in, e.g., FIG. 17A (the broken line in FIG. 17A represents a trajectory obtained by sliding the finger), in addition to a operation of checking a checkbox as described above. FIG. 17A shows an example of selecting contact objects. The above configuration may also be applied to the second operation for selecting applications.

In the embodiment and the first through third modifications, one contact icon 43 to be displayed on the first screen 41 corresponds to one contact object. Alternatively, for instance, as shown in FIG. 17B, it may be configured to display contact icons 43d, 43e and 43f corresponding to a plurality of contact objects on the first screen 41. A plurality of contact objects are correlated in advance to each of the contact icons 43d, 43e and 43f. The user is allowed to select a group of contact objects by selecting one contact icon.

In the selection receiving processing, it is possible to configure in such a manner that after selection of one or more contact objects and one or more applications is received, an execute key 46 indicating receiving a user's operation for executing the application(s) is displayed on a display surface 3. A receiving module 33 receives a user's operation for selecting a plurality of contact objects on a first screen 41 by the first operation, and receives a user's operation for selecting a plurality of applications on a second screen 42 by the second operation until the operation with respect to the execute key 46 is received.

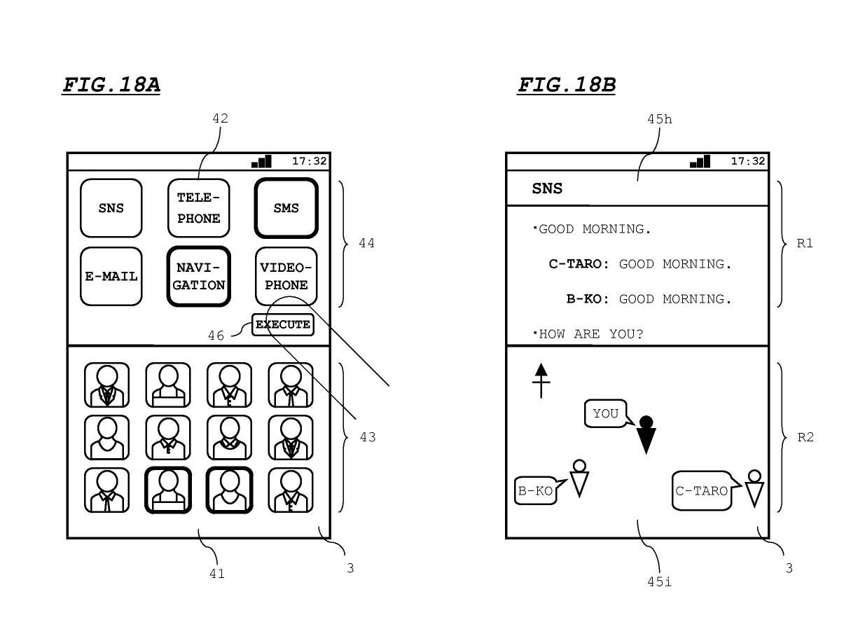

For instance, as shown in FIG. 18A, a user's operation with respect to the execute key 46 may be performed after two applications (SNS application and navigation application) and two contact objects A2 and A3 are selected. In this case, a program executing module 34 activates the selected two applications and applies, to each of the applications, acquired contact information of the two contact objects. As a result of the above operation, as shown in FIG. 18B, a control module 11 displays, in a region R1, an execution screen 45h of the SNS application utilizing the contact information 22 of the two contact objects, and displays, in a region R2, an execution screen 45i of the navigation application utilizing the contact information 22 of the two contact objects.

The configuration of the third modification may be applied to the first modification or to the second modification. In a state that a plurality of contact objects are selected, the receiving module 33 invalidates selection of an application incapable of utilizing contact information 22 of one or all of the selected contact objects. In a state that a plurality of applications are selected, the receiving module 33 invalidates selection of a contact object that does not have contact information 22 of an item or items corresponding to one or all of the selected applications. In this case, for instance, it may be configured to highlight icons (contact icon 43 and application icon 44) whose selection is validated.

In the embodiment and the first through third modifications, contact information 22 and applications are stored in the storage module 12. Alternatively, it may be configured to store contact information 22 and applications in an external storage module of the mobile phone 1. For instance, contact information 22 and applications may be stored in a storage module such as a server to be connected via a communication network. In the above modification, the acquiring module 31 acquires information necessary for the contact information 22 and the applications by communication via the communication network.

In the embodiment and the first through third modifications, contact information 22 is applied to an application. Alternatively, the program executing module 34 may be configured to apply, to an application, information indicating a contact object, in place of the contact information 22. In the above modification, the program executing module 34 acquires contact information of a predetermined item of a selected contact object by a method in accordance with an application to be executed, and further applies the acquired contact information to the application in execution.

The mobile phone 1 in the embodiment is provided with one display surface 3. However, the configuration of the embodiment may be applied to a mobile phone 1 provided with two or more display surfaces. For instance, in the case where a mobile phone 1 is provided with two display surfaces, it is possible to configure in such a manner that a first screen and a second screen based on an activation control processing are displayed on the respective display surfaces. For instance, in the case where the second operation for selecting two applications is received, regions for displaying execution screens of the two applications are allocated to the respective display surfaces.

In the embodiment, an application is activated in response to a user's operation (first operation and/or second operation) of touching an icon (contact icon 43 and/or application icon 44). Alternatively, it may be configured to activate an application in response to a user's operation other than touching.

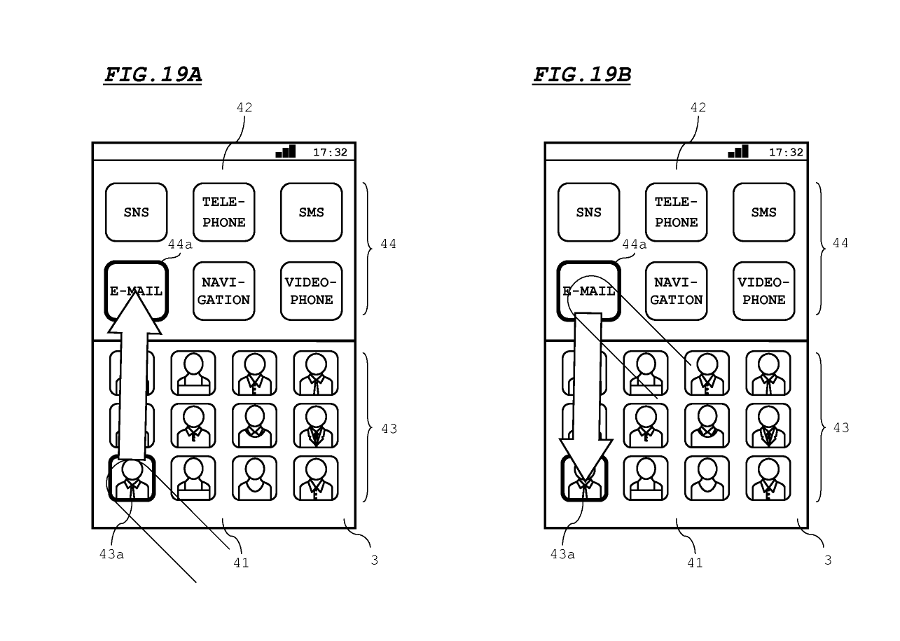

For instance, as shown in FIG. 19A, it may be configured to activate an application based on a user's operation of sliding the finger from a contact icon 43a onto an application icon 44a. In the above modification, the operation of touching the contact icon 43a by the finger corresponds to the first operation, and the operation of releasing the finger on the application icon 44a corresponds to the second operation. As shown in FIG. 19B, it may be configured to activate an application based on a user's operation of sliding the finger in a direction opposite to the direction exemplified in FIG. 19A. In the above modification, the operation of touching the application icon 44a with the finger corresponds to the second operation, and the operation of releasing the finger on the contact icon 43a corresponds to the first operation.

In the embodiment and the first through third modifications, execution of an execution screen of the activation control processing may be started at any timing. For instance, an execution screen of the activation control processing may be displayed on the display surface 3 in response to receiving a user's predetermined operation in a state that a list of address book or a list of applications is displayed on the display surface 3.

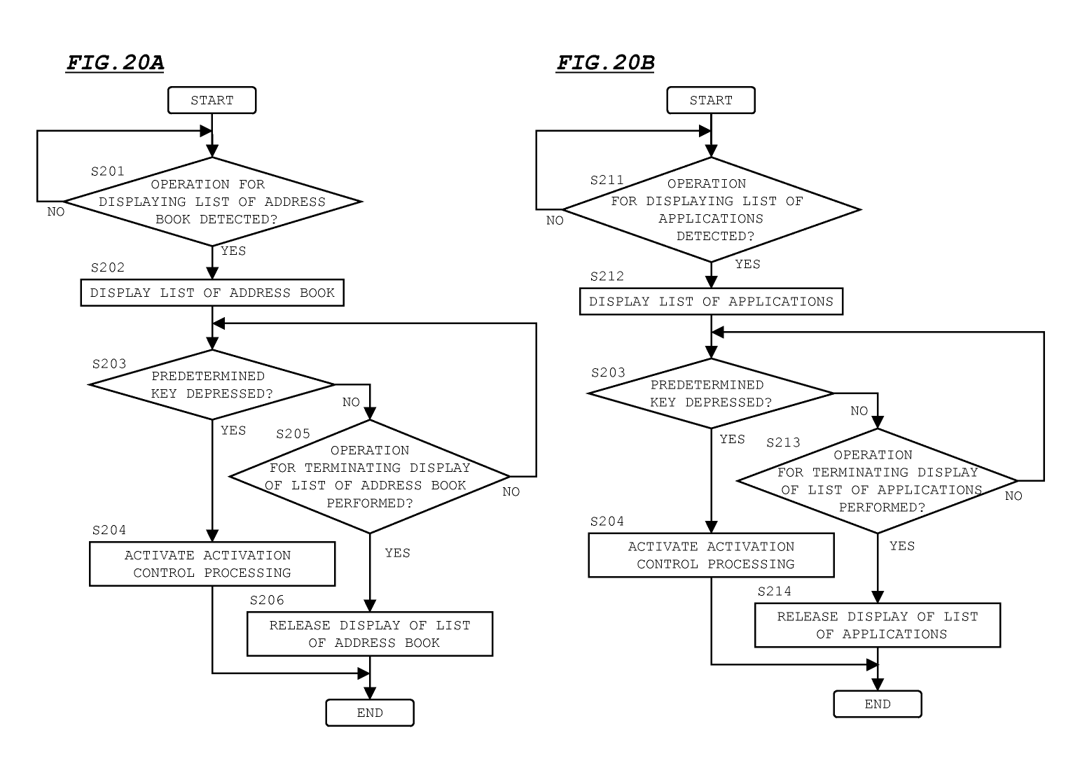

FIG. 20A is a flowchart showing a processing for activating the activation control processing in a state that a list of address book is displayed on a display surface 3. In response to a user's operation for displaying a list of address book (S201: YES), a control module 11 displays, on the display surface 3, a screen indicating the list of address book (S202). Then, in response to a user's operation of depressing a predetermined key (e.g. the leftmost key in the key operation part 7 shown in FIG. 1) (S203: YES), the control module 11 activates the activation control processing (S204). In the case where a user's operation for terminating the display of the list of address book is performed before the predetermined key is depressed (S203: NO→S205: YES), the control module 11 releases the display of the list of address book (S206), and terminates the processing shown in FIG. 20A.

FIG. 20B is a flowchart showing a processing for activating the activation control processing in a state that a list (launcher screen) of applications is displayed on the display surface 3. In response to a user's operation for displaying a list of applications (e.g., a operation of depressing the leftmost key in the key operation part 7 shown in FIG. 1) (S211: YES), the control module 11 displays, on the display surface 3, a screen indicating the list of applications (S212). Then, in response to a user's operation of depressing a predetermined key (e.g., the leftmost key in the key operation part 7 shown in FIG. 1) (S203: YES), the control module 11 activates the activation control processing (S204). In the case where a user's operation for terminating the display of the list of applications is performed before the predetermined key is depressed (S203: NO→S213: YES), the control module 11 releases the display of the list of applications (S214), and terminates the processing shown in FIG. 20B.

In the embodiment, the present invention is applied to mobile phones called smartphones. Alternatively, the invention may be applied to other types of mobile phones such as straight-type mobile phones, foldable mobile phones, slidable mobile phones, etc.

Furthermore, the invention is not limited to the mobile phones. Alternatively, the invention is applicable to mobile terminal devices such as PDAs (Personal Digital Assistants), tablet PCs, electronic book readers, etc.

The embodiment of the present invention may be modified variously and suitably within the scope of the technical idea described in claims.

What is claimed is:

1. A mobile terminal device, comprising:
a display module;
an image generating module which generates a first image by which an user selects one of a plurality of contact objects respectively correlated to contact information and a second image by which the user selects one of a plurality of application programs utilizing contact information, and displays the first image and the second image on the display module;
a receiving module which receives a first operation with respect to the first image and a second operation with respect to the second image; and
an executing module which executes a processing of activating the application program selected by the second operation, and of applying, to the activated application program, the contact information correlated to the contact object selected by the first operation, as contact information to be utilized in the activated application program, based on a determination that the first operation and the second operation are received by the receiving module.

2. The mobile terminal device according to claim 1, wherein
the contact object is correlated to the contact information of a plurality of items,
the executing module holds correspondence information for specifying the item corresponding to the application program, and
the executing module applies, to the activated application program, the contact information of the item corresponding to the application program selected by the second operation, among the contact information of the plurality of items correlated to the contact object selected by the first operation, as the contact information to be utilized.

3. The mobile terminal device according to claim 2, wherein
the item includes at least one of a name of the contact object, a telephone number, an electronic mail address, a location, a connection destination for utilizing a social networking service (SNS), and a connection destination for utilizing a predetermined on-line service.

4. The mobile terminal device according to claim 1, wherein
the receiving module receives, as the first operation, a operation by which the user selects the plurality of contact objects with respect to the first image, and
the executing module applies, to the activated application program, the contact information correlated to each of the contact objects selected by the first operation, as the contact information to be utilized.

5. The mobile terminal device according to claim 4, wherein
the executing module activates the application program selected by the second operation by a same number as the number of the contact objects selected by the first operation, and applies, to each of the activated application programs, the contact information correlated to each of the contact objects selected by the first operation, as the contact information to be utilized.

6. The mobile terminal device according to claim 1, wherein
the receiving module receives, as the second operation, a operation by which the user selects the plurality of application programs with respect to the second image, and
the executing module activates each of the application programs selected by the second operation, and applies, to each of the activated application programs, the contact information correlated to the contact object selected by the first operation, as the contact information to be utilized.

7. The mobile terminal device according to claim 1, wherein
the receiving module invalidates the second operation, with respect to the second image, by which the user selects the application program incapable of utilizing the contact information correlated to the selected contact object in a state that the contact object is selected by the first operation.

8. The mobile terminal device according to claim 1, wherein
the receiving module invalidates the first operation, with respect to the first image, by which the user selects the contact object that is not correlated to the contact information usable by the selected application program in a state that the application program is selected by the second operation.

9. A storage medium which stores a computer program for providing a computer of a mobile terminal device with:
a function of generating a first image by which an user selects one of a plurality of contact objects respectively correlated to contact information and a second image by which the user selects one of a plurality of application programs utilizing contact information, and of displaying the first image and the second image on a display module;
a function of receiving a first operation with respect to the first image and a second operation with respect to the second image; and
a function of activating the application program selected by the second operation, and of applying, to the activated application program, the contact information correlated to the contact object selected by the first operation, as contact information to be utilized in the activated application program, based on a determination that the first operation and the second operation are received.

10. An application execution control method for a mobile terminal device, comprising:
a step of generating a first image by which an user selects one of a plurality of contact objects respectively correlated to contact information and a second image by which the user selects one of a plurality of application programs utilizing the contact information, and of displaying the first image and the second image on a display module;
a step of receiving a first operation with respect to the first image and a second operation with respect to the second image; and
a step of activating the application program selected by the second operation, and of applying, to the activated application program, the contact information correlated to the contact object selected by the first operation, as contact information to be utilized in the activated application program, based on a determination that the first operation and the second operation are received.
